(19) United States
(12) Patent Application Publication
(10) Pub. No.: US 2012/0033466 A1
(43) Pub. Date: Feb. 9, 2012

(54) PARTIAL POWER MICRO-CONVERTER ARCHITECTURE

(75) Inventor: Zaki Moussaoui, San Carlos, CA (US)

(73) Assignee: INTERSIL AMERICAS INC., Milpitas, CA (US)

(21) Appl. No.: 13/158,711

(22) Filed: Jun. 13, 2011

Related U.S. Application Data
(60) Provisional application No. 61/370,731, filed on Aug. 4, 2010.

(51) Int. Cl. H02J 1/10

(52) U.S. Cl. 363/65

(57) ABSTRACT

A system and method for reducing the amount of power processed in a power converter during power generation is provided. In one aspect, the system includes a partial power converter connected between a set of power sources and a load. The partial power converter includes a primary power converter coupled to a first power source and a set of auxiliary power converters coupled to the remaining power sources. Moreover, the secondary power converters only process current that is necessary to achieve a maximum power point (MPP) for each power source. In one example, the secondary power converters are smaller in size and/or power rating, as compared to the primary power converter, and thus reduce the size and cost of the system. Additionally, the secondary power converters operate on an “as-needed” basis rather than in “always-on” fashion, and thus are more reliable and efficient.

### CROSS-REFERENCE TO RELATED APPLICATIONS

This application is related to and claims priority from U.S. Provisional Patent Application Ser. No. 61/370,731, filed on Aug. 4, 2010, and entitled “PARTIAL MICRO-CONVERTER METHOD AND APPARATUS FOR SOLAR APPLICATIONS.” The entirety of above-captioned U.S. Provisional Patent Application is incorporated by reference herein.

### BRIEF DESCRIPTION OF THE DRAWINGS

The numerous aspects, embodiments, objects and advantages of the subject disclosure will be apparent upon consideration of the following detailed description, taken in conjunction with the accompanying drawings, in which like reference characters refer to like parts throughout, and in which:

FIG. 1 illustrates an example system that provides a low-cost partial micro-converter, utilized during power generation;

FIG. 2 illustrates a high level diagram of components within a partial power converter that is utilized for correcting a mismatch error during power generation;

FIG. 3 illustrates an improved solar power generation system that utilizes a partial micro-converter architecture;

FIGS. 4A-B illustrate the operation of a power generation system that utilizes a partial power converter architecture for regulating voltage and/or current output by a power source;

FIGS. 5A-D illustrate graphs depicting an example embodiment for maximizing the efficiency of a power generating source;

FIG. 6 illustrates another embodiment of a partial power controller architecture utilized during power generation; and

FIG. 7 illustrates a methodology for efficiently generating power by detecting and eliminating power mismatches between panels in an array of power sources.

### DETAILED DESCRIPTION

Various aspects or features of the subject disclosure are described with reference to the drawings, wherein like reference numerals are used to refer to like elements throughout. In the subject specification, numerous specific details are set forth in order to provide a thorough understanding of the subject disclosure. It may be evident, however, that the disclosed subject matter may be practiced without these specific details, or with other methods, components, materials, etc. In other instances, well-known structures and devices are shown in block diagram form in order to facilitate describing the subject disclosure.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

Moreover, the word “exemplary” or “example” is used herein to mean serving as an example, instance, or illustration. Any aspect or design described herein as “exemplary” or “an example” is not necessarily to be construed as preferred or advantageous over other aspects or designs. Rather, use of the word “exemplary” or “example” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. In addition, the word “coupled” is used herein to mean direct or indirect electrical or mechanical coupling.

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders not illustrated.

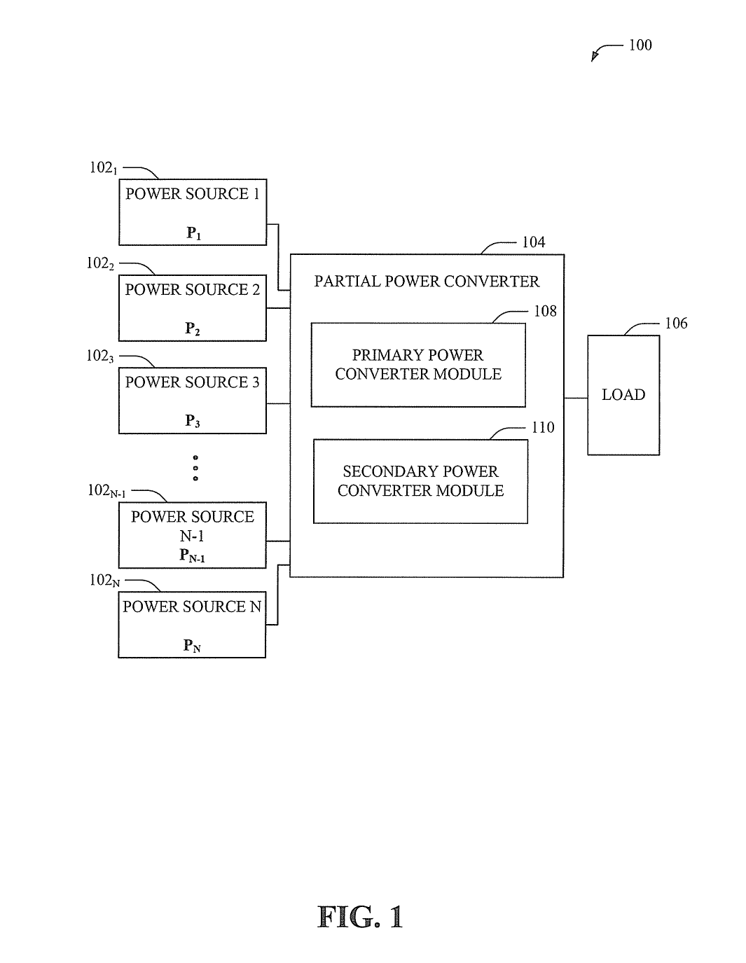

Referring to FIG. 1, there illustrated is an example system 100 that provides a low-cost partial micro-converter 104, utilized during power generation. As used herein, the terms “partial converter,” “partial power converter” and/or “partial micro-converter” refer to a converter system wherein at least a portion of the converters (or micro-converters) are utilized in an “as needed basis”, rather than continuously. Renewable and alternate energy solutions have gained increased importance and demand with a rise in fossil fuels costs and depletion of fossil fuels resources. One aspect of power generation is to maximize the power generated by the power sources 102_{1-N} (where N is an integer and 102_{1-N} means 102₁ to 102_{N}). Power sources 102_{1-N}, for example, photovoltaic (PV) cells, typically have an operating point where the current and voltage for an electrical load on the power source results in maximum power production by the power source. Moreover, the operating point of the power source is adjusted to a maximum power point (MPP) to harvest a maximum amount of power. This adjustment of the voltage and current is referred to as maximum power point tracking (MPPT). In general, the MPP is a function of individual operating characteristics of each power source 102_{1-N}, such as, but not limited to, temperature, and/or the light intensity.

Harvesting the maximum amount of energy from a power source is desirable, as well as minimizing system size and controlling equipment reliability and/or cost. Typically, the power sources 102_{1-N} do not always operate at their MPPs. In an embodiment of the present invention, a partial power converter 104 (e.g., power micro-converter) can be provided to facilitate electric power management. Moreover, the partial power converter 104 can match the impedance of the power sources 102_{1-N} to the impedance of the load 106 and enable the power sources 102_{1-N} to operate at their MPPs. In one example, the partial power converter 104 processes only a mismatch of the power sources 102_{1-N} and not the entire power capability of each power source 102_{1-N}. Specifically, the partial power converter 104 identifies the amount of mismatch and adaptively makes corrections to try to eliminate the mismatch. It can be appreciated that the term “mismatch” as utilized herein refers to a mismatch that occurs due to a difference between the impedance of the power sources 102_{1-N} and the impedance of the load 106. The term “mismatch” also refers to the differences in the individual power outputs of the various power sources 102_{1-N}. The partial power converter 104 compensates for this mismatch and enables the power sources 102_{1-N} to operate at their MPP.

The partial power converter 104 can include a primary power converter module 108, comprising at least one power converter that processes the entire power capability of a power source, to which it is connected. Further, the partial power converter 104 can include a secondary power converter module 110, comprising one or more power converters, that process only a mismatch of the power sources, to which they are connected. The power converter within the primary power converter module 108 is rated to a power output that is substantially higher than that of a power converter within the secondary power converter module 110. Moreover, the primary power converter module 108 can be coupled to a first power source, for example, power source 1 (102₁), whereas the secondary power converter module 110 can be coupled to the remaining power sources P2-PN (102_{2-N}). Moreover, the secondary power converter module 110 only processes current that is necessary to achieve MPP for each power source 102_{1-N}. Accordingly, the secondary power converter module 110 need not boost power output at all times. For example, if there is no mismatch then current is not pushed from the secondary power converter module 110.

The partial power converter 104 disclosed herein, provides an efficient mechanism for regulating output power in the system 100. Specifically, the partial power converter 104 reduces the amount of power processing needed during power generation, thus reducing the cost and the improving the efficiency of system 100. In particular, since the secondary power converter module 110 can include power converters with a low power rating, cost and size of the system 100 is reduced. In addition, the secondary power converter module 110 operates on an “as-needed” basis rather than in “always-on” fashion, and thus is more reliable and efficient. In other words, the secondary power converter module 110 is used for correcting the mismatch only if a mismatch is detected by the secondary power converter module 110.

It can be appreciated that the design of system 100 can include different component selections, electrical circuits, etc., to process the mismatch in the power sources 102_{1-N}. Moreover, it can be appreciated that the partial power converter 104 can include most any electrical circuit(s) that can include components and circuitry elements of any suitable value in order to implement the embodiments of the subject disclosure. Furthermore, it can be appreciated that the components of system 100 can be implemented on one or more integrated circuit (IC) chips. For example, in one embodiment, partial power converter 104 is implemented in a single IC chip. In other embodiments, one or more of primary power converter module 108 and secondary power converter module 110 are fabricated on separate IC chips.

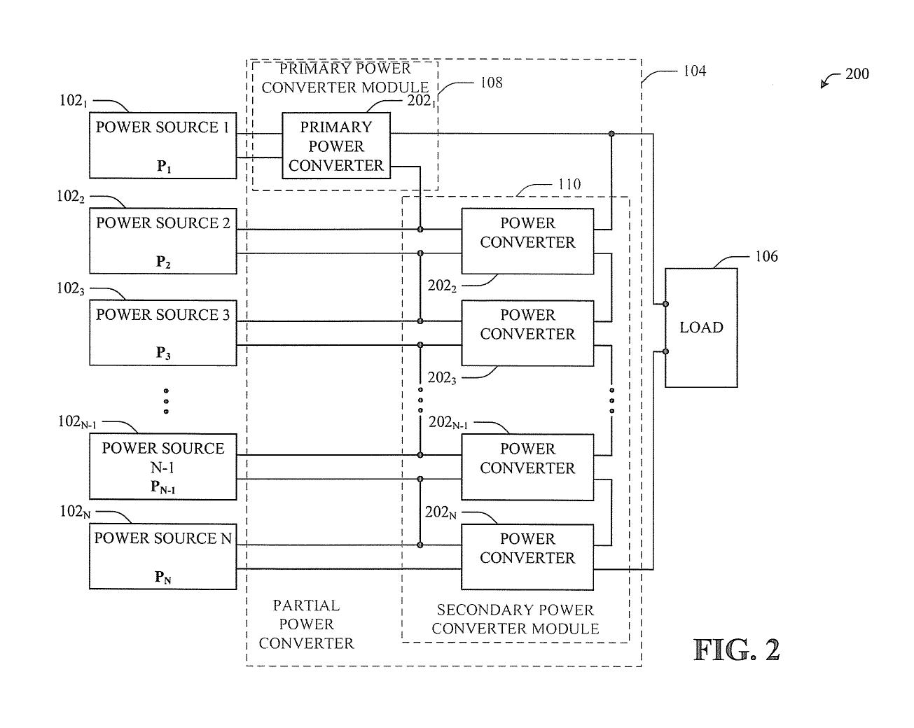

Referring to FIG. 2 there illustrated is an example system 200 depicting a high level diagram of components within a partial power converter 104 utilized during power generation in accordance with an aspect of the subject disclosure. As discussed supra, an array of power sources, for example, power sources 102_{1-N} can be utilized to convert energy (e.g., sunlight) into electrical power. To deliver the maximum amount of power to the load 106, a partial power converter 104 is placed between the power sources 102_{1-N} and the load 106 in order to match the impendence of the power sources 102_{1-N} to that of the load 106. Various factors (e.g., temperature, damage, etc.) can change the power output of the power sources 102_{1-N} and also change the ratio of current to voltage of the MPP. For example, the voltage at the MPP generally stays about the same, but the current at the MPP increases with decreasing temperature.

The partial power converter 104 disclosed herein locates and tracks the MPPs of the power sources 102_{1-N}, and operates the power sources 102_{1-N} at their MPPs. In one aspect, the partial power converter 104 facilitates regulating the current and voltage from a primary power source (e.g., power source P₁, 102₁) by using a primary power converter 202₁. Typically, the primary power converter 202₁ can include most any direct current (DC)-DC boost converter with a power rating that is equal to, or substantially equal to, the maximum power rating of the primary power source P₁, 102₁. Moreover, the primary power converter 202₁ is configured to process the entire power capability of the primary power source P₁, 102₁. Further a set of secondary converters 202_{2-N} are connected as shown in FIG. 2, such that each of secondary converters 202_{2-N} N process the power mismatch of the respective power sources 102_{2-N}, instead of the entire power capability of the power sources 102_{2-N}. Typically, secondary converters 202_{2-N} can comprise most any DC-DC boost converters (e.g., bi-directional DC-DC micro converters). In one example, the power rating of the secondary converters 202_{2-N} can be substantially less than that of the primary power converter 202₁. Moreover, the primary power converter 202₁ includes an MPP tracker algorithm that tracks the MPP of the power source array 102_{1-N}, and the isolated, smaller secondary converters 202_{2-N} are controlled by respective MPP trackers to process only the power due to mismatch between each power source in the array 102_{1-N}. Accordingly, conversion efficiency and power output can be increased.

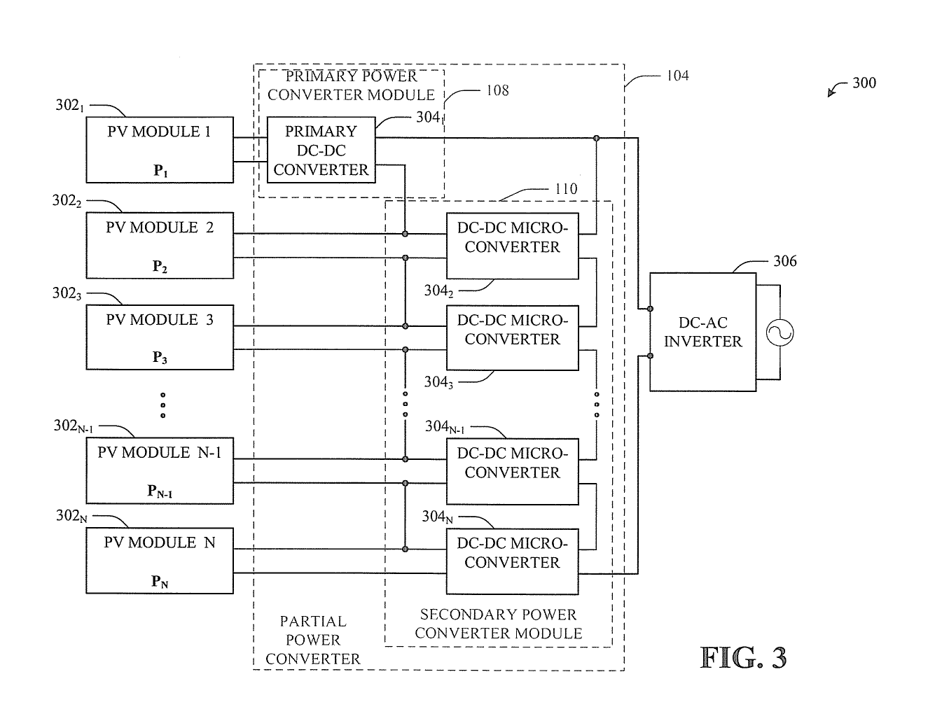

Referring now to FIG. 3, there illustrated is an improved solar power generation system 300 that utilizes a partial micro-converter architecture, according to an aspect of the subject disclosure. The solar power generation system 300 typically includes a solar array comprising a set of photovoltaic (PV) modules/panels 302_{1-N} (N is a natural number). In one example, the PV modules 302_{1-N} include an interconnected assembly of solar cells, which generate electricity from solar energy (e.g., sunlight) based on a photovoltaic principle. The electricity, for example DC power, generated by the PV modules 302_{1-N} is converted to an alternating current (AC) by a DC-AC inverter 306. The AC output of the DC-AC inverter 306 can be utilized to supply power to various electrical systems and/or devices utilized in various environments, including, but not limited to, residential, commercial, industrial, and the like.

According to an embodiment, the partial power converter architecture disclosed herein can be exploited in solar-energy conversion applications, to regulate power output of the PV modules 302_{1-N} while reducing the size and cost of the system 300. In general, the partial power converter 104 comprises one or more power converters that locate and track the MPP of a PV module and operate the PV module at, or substantially at, the MPP. The power converter 104 operates the PV modules 302_{1-N} by adjusting their power outputs. In an aspect, the partial power converter 104 is designed in a manner, such that the output of a primary DC-DC boost converter 304₁, connected to a solar array, includes a MPPT method/algorithm to track the MPP of the entire solar array, and the secondary DC-DC micro-converters 304_{2-N} are controlled via the MPPT method to process only the mismatch in power output between each module 302_{1-N} in the solar array, thereby increasing conversion efficiency and increasing power output. As an example, the primary DC-DC converter 304₁ can have a capacity of 200 Watts (W), although the selection of this DC-DC converter 304₁ can be based upon the size and/or output of the PV module 302₁, to which it is connected. In one aspect, the secondary DC-DC micro-converters 304_{2-N} can include bidirectional DC-DC micro-converters. Typically, the secondary DC-DC micro-converters 304_{2-N} are boost converters that are substantially smaller (e.g., in size and power rating) than the primary DC-DC boost converter 304₁. For example, the size of the secondary DC-DC micro-converters 304_{2-N} can typically be 20-50 W, although again, the selection of these DC-DC micro-converters may be based on the size of the PV modules 302_{2-N} to which they are connected.

A PV module 302ⱼ, with j a natural number and j=1, 2 . . . N, has an MPP represented by a voltage V_{MPP}^{(j)} and/or current I_{MPP}^{(j)}. During operation, electric power in the array can be lost because power output of a PV module 302ⱼ can be lower than power output attained at V_{MPP}^{(j)}, or at MPP, due to various factors (e.g., shading, soiling, temperature changes, etc.) that shift the output of PV module 302ⱼ from operation at MPP. In an aspect, if one or more PV modules 302ⱼ in the solar array does not produce substantially its rated power output (e.g., such as when the PV module 302ⱼ is highly shaded), the partial power converter 104 can supply the necessary current to boost the power output of the PV module 302ⱼ and enable power output at, or nearly at, MPP of the PV module 302ⱼ in order to maintain the overall efficiency of the solar array. Specifically, the DC-DC converters 304ⱼ are utilized to compensate for the power loss of the PV module 302ⱼ. It can be appreciated that in the subject disclosure, a DC-DC power converter is also referred to as DC-DC converter.

A DC-DC converter 304ⱼ regulates (e.g., boosts) the power output of PV module 302ⱼ to, or nearly to, peak power output thereof as dictated by V_{MPP}^{(j)} and I_{MPP}^{(j)}. The DC-DC converter 304ⱼ regulates the power output of PV module 302ⱼ with an efficiency ηⱼ, which is a positive real number smaller or equal to unity (1). Accordingly, depending on the value of ηⱼ, a portion of that power can be lost in the DC-DC converter 304ⱼ. The efficiency ηⱼ is determined by various factors, such as, but not limited to, connectors (e.g., single-conductor wire, multiple-conductor wire, etc.) employed to couple DC-DC converter 304ⱼ to the PV module 302ⱼ, circuitry configured and utilized in DC-DC converter 304ⱼ to convert input power, or the like. Regulation, or conversion, efficiency of power micro-converters is typically greater than the regulation efficiency of larger power converters; thus, the greater efficiency of DC-DC micro-converters 304_{2-N} generally results in smaller loss of power through the converters 304_{2-N} within the secondary power converter module 110, when compared to loss of power in a larger power converter. According to an aspect, DC-DC converter 304ⱼ can execute at least one MPPT method, or procedure, to identify the MPP of PV module 302ⱼ and regulate electric power output thereof to a power level substantially at peak power output.

In one aspect, system 300 operates based at least in part on the concept that most fluctuations from the MPP of the PV modules 302_{1-N} are caused by power mismatches between the PV modules 302_{1-N} and not substantially due to total shading (or damage to one or more arrays). The partial micro-converter system 300 leverages this concept to enable the use of DC-DC micro-converters 304_{2-N} to compensate for small mismatches between the PV modules 302_{1-N}, so that each PV module 302_{1-N} operates at or substantially at its MPP. Because the DC-DC micro-converters 304_{2-N} primarily correct mismatched power between panels, they operate infrequently and far from their rated capacity, increasing the efficiency of the array and longevity of the secondary power converter module 110, while reducing the cost of components in the system 300.

As an example, consider a scenario wherein the primary DC-DC converter 304₁ is rated for a power output of 200 W, with an efficiency of about 95 percent and each of the DC-DC micro-converters 304_{2-N} are rated for a power output of 50 W, with an efficiency of about 95 percent. Accordingly, a loss of approximately only 2.5 W occurs when the DC-DC micro-converters 304_{2-N} operate. For similarly mismatched PV modules 302_{1-N}, each of the DC-DC micro-converters 304_{2-N} can recover 5 W of power while utilizing only 2.5 W, which can result in a net gain of 2.5 W per PV module/micro-converter pair. However, if no mismatch exists between the PV modules 302_{1-N}, no power will flow through the DC-DC micro-converters 304_{2-N} and thus no power will be lost. According to this example and as shown in the subject disclosure, the use of the partial power converter 104 coupled to a PV array results in an efficient mechanism for power processing. In addition, the smaller DC-DC micro-converters 304_{2-N} utilized within the secondary power converter module 110 can enable more compact arrays and thus reduce size of the system 300. Further, the smaller DC-DC micro-converters 304_{2-N} are less expensive and can provide a low-cost system. Furthermore, the DC-DC micro-converters 304_{2-N} operate “as needed” instead of as “always on,” thereby increasing the life of the DC-DC micro-converters 304_{2-N} and reducing replacement/repair costs.

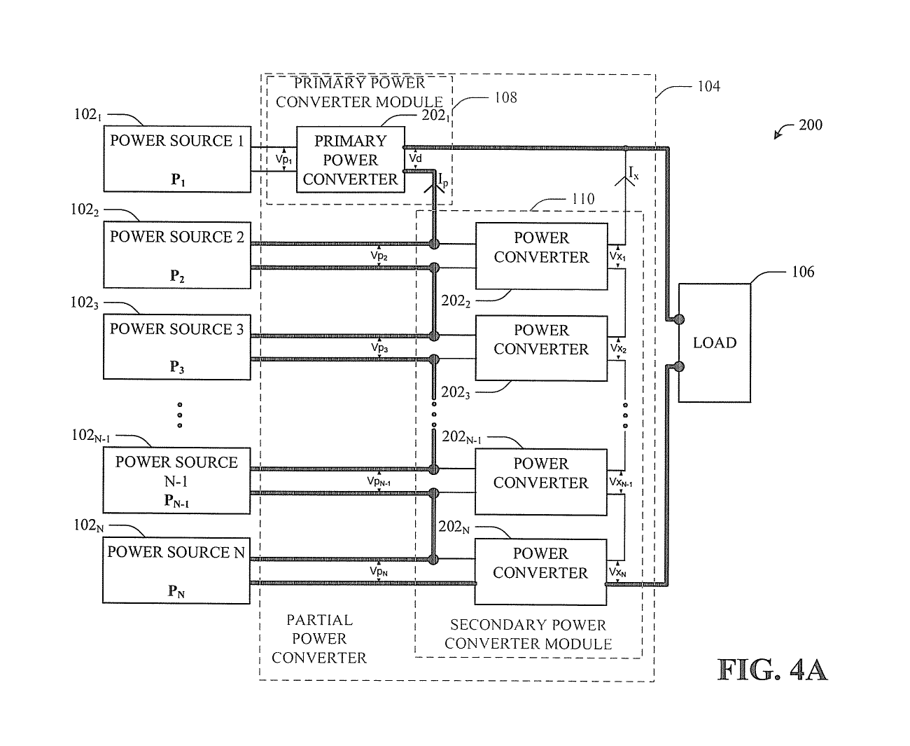

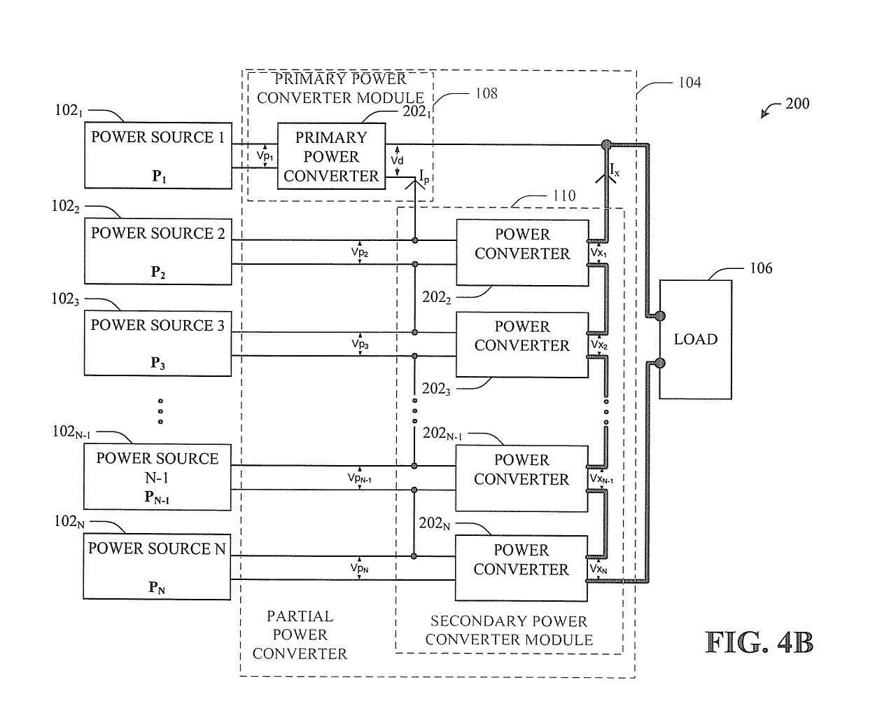

FIGS. 4A-B illustrate the operation of system 200 that utilizes a partial power converter architecture for regulating voltage and/or current output by a power source, according to an aspect of the subject disclosure. Typically, two paths, namely, a high current path and a low current path, are available to supply electric power to load 106. FIG. 4A illustrates the high current path, whereas FIG. 4B illustrates the low current path. It can be appreciated that system 200 can be utilized in solar applications, wherein the power sources 102_{1-N} can include PV panels, the power converters 202_{1-N} can include DC-DC boost converters, and load 106 can include a DC-AC inverter (as depicted by example system 300). The load 106 can include residential, commercial or industrial loads and power generators.

Referring now to FIG. 4A, during a first mode of operation of the system 200, when the power sources 102_{1-N} are operating at their MPP and/or no mismatch occurs between the power sources 102_{1-N}, the current follows the highlighted path/branch, termed as a “high current path” herein. During this mode of operation, the partial power converter 104 enables bypassing the boost operation of the secondary power converters 202_{2-N}. The high current path of the primary converter 202₁ is connected to a first input of a load 106, for example a DC-AC inverter. Typically, Ip is the current that circulates through the power sources 102_{1-N} without processing by the secondary power converters 202_{2-N}, and Ix is the current pushed as result of a DC-DC boost operation performed by the secondary power converters 202_{2-N} (during a second mode of operation). In the first mode of operation, Ix is equal to zero. Moreover, the secondary power converters 202_{2-N} do not boost power output from the power sources 102_{2-N} at all times. For example, if no mismatch is detected by the secondary power converter module 110, then current Ix is not pushed from the secondary power converters 202_{2-N}. Accordingly, the system 200 is efficient and reliable.

In general, mismatch can be present amongst power sources 102_{1-N} due to various reasons. For example, mismatch can occur due to manufacturing variations/fluctuations. Additionally, in solar applications, mismatch can occur based on time of day, shading changes, temperature changes etc. Typically, the mismatch is not present all the time, except that from manufacturing variations/fluctuations. Shading changes, temperature changes, etc., vary with time and accordingly vary the mismatch. For example, may not be present amongst the power sources 102_{1-N} at all times. Specifically, during the times when mismatch is not present, boost operation is not performed (e.g., by the secondary power converters 202_{2-N}) and no current flows through the secondary power converters 202_{2-N}. Moreover, during the times when mismatch is present, the secondary power converters 202_{2-N} simply process the power that is required to compensate for the mismatch and achieve MPP, as shown in FIG. 4B.

FIG. 4B illustrates a second mode of operation of the system 200, wherein at least one of the power sources 102_{1-N} is not operating at its respective MPP and/or mismatch occurs between the power sources 102_{1-N}. In this example scenario, the current flows through the secondary power converters 202_{2-N}, as depicted by the highlighted path/branch, termed as a “low current path” herein. The low current path is connected from the first secondary power converter 202₂ to a first input of the load 106 in order to receive power from the secondary power converter 202_{2-N}. Further, a portion of the low current path is connected from the second secondary power converter 202₃ to the first secondary power converter 202₂. As an example, in a system with N power sources 102_{1-N}, having a partial power converter 104 that includes one primary power converter 202₁ and N−1 secondary power converters 202_{2-N}, this connection is repeated until the low current path is connected from the secondary power converter 202_{N} to the secondary power converter 202_{N-1}.

Moreover, the secondary power converters 202_{2-N} process power that is necessary to achieve MPP for the power sources 102_{2-N} and accordingly compensate for the mismatch between the power sources 102_{2-N}. For example, if Ip=5 Amperes (A), but for operation at MPP Ip=5.5 A is required, secondary power converters 202_{2-N} pushes 0.5A through low current path (e.g., Ix=0.5A). In the example system 200, the output voltage of each power source Pᵢ is Vpᵢ (wherein i=1, 2, 3 . . . N), the output voltage of the primary power converter 202₁ is Vd and the output voltage of the i^{th} secondary power converter is Vxᵢ (wherein i=1, 2, 3 . . . N). Further, as noted above, Ip is the current that flows through the power sources 102_{1-N} without processing by the secondary power converters 202_{2-N}, and 1x is the current pushed as result of a boost operation performed by the secondary power converters 202_{2-N}. Furthermore, Pᵢ is the power output from the power source 102, (wherein i=1, 2, 3 . . . N). A simplified mathematical proof that describes the operation of system 200, for example, when N=3, is described as follows:

$${V}_{x 1} \cdot {I}_{p} = {P}_{1}$$

$${I}_{p} \cdot {V}_{p 2} + {I}_{x} \cdot {V}_{x 2} = {P}_{2} \\ {I}_{p} \cdot {V}_{p 3} + {I}_{x} \cdot {V}_{x 3} = {P}_{3} \\ {V}_{x 1} + {V}_{p 2} + {V}_{p 3} = \frac{{P}_{1} + {P}_{2} + {P}_{3}}{{I}_{p} + {I}_{x}} \\ {V}_{x 2} + {V}_{x 3} = \frac{{P}_{1} + {P}_{2} + {P}_{3}}{{I}_{p} + {I}_{x}}$$

As it can be seen from the foregoing set of equations, namely that there are five equations and five unknowns, there is a unique equilibrium solution that will push the high current through the power sources 102_{1-N} via the high current path (depicted in FIG. 4A), while the low current through the secondary power converters 202_{2-N} via the low current path (depicted in FIG. 4B).

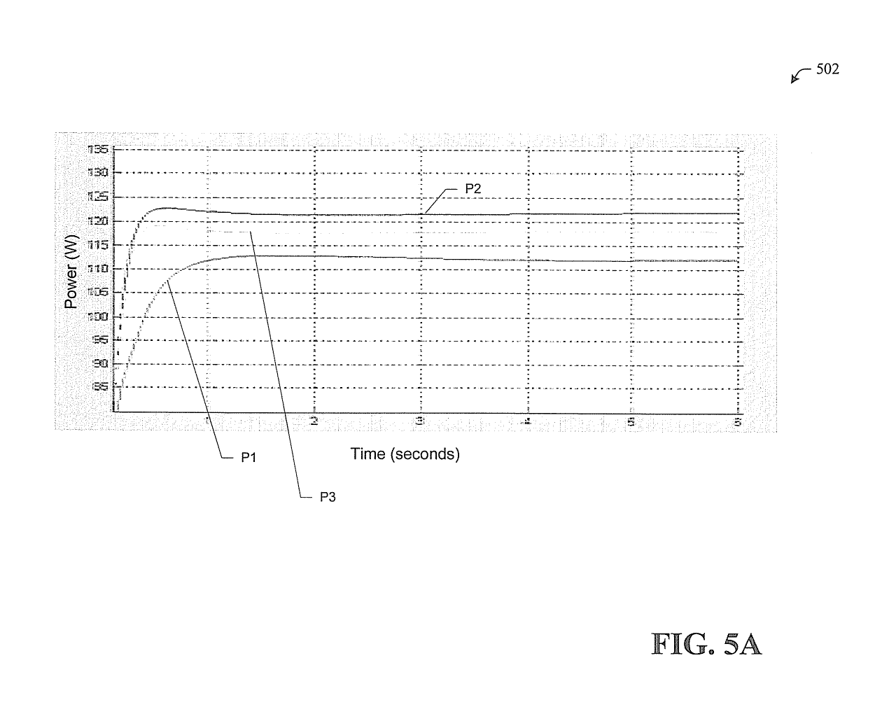

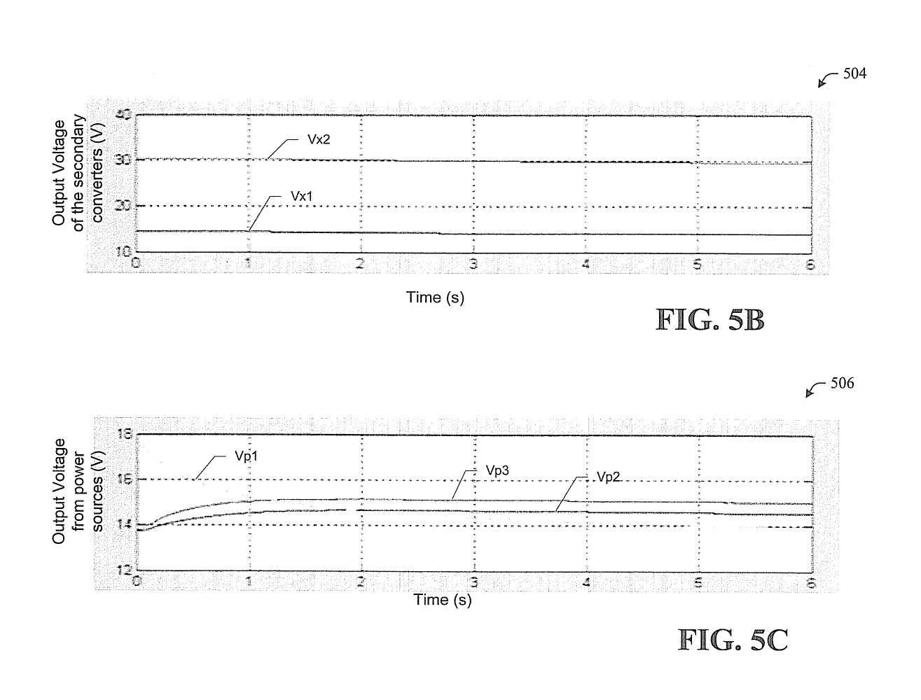

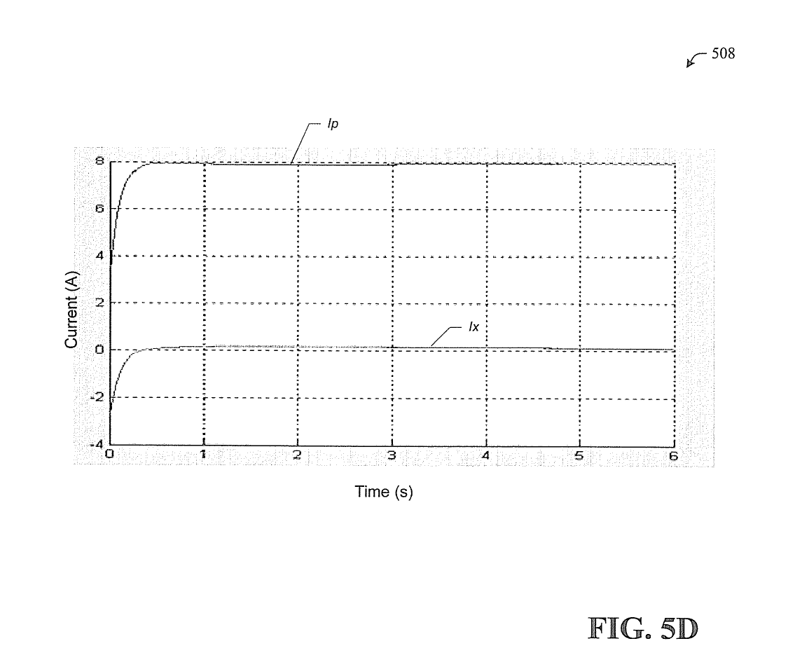

FIGS. 5A-D illustrate graphs 502-508 depicting an example embodiment for maximizing the efficiency of a power generating source according to the subject disclosure. These graphs 502-508 depict measurements from various nodes in system 200, when N=3, and validate the mathematical analysis supra. Consider an example scenario when the power sources have a +/−5% mismatch. FIG. 5A illustrates the power generated by power sources P₁₋₃. As seen in graph 502, the maximum power generated by the respective power sources P₁₋₃ is: P₁=112 W, P₂=124 W, and P₃=118 W. In addition, graph 506 in FIG. 5C illustrates the output voltages (Vp₁₋₃) across the power sources P₁₋₃. For example, the steady state values for output voltages are: Vp₁=14 V, Vp₂=14.4 V, and Vp₃=14.8 V.

Further, graph 504, in FIG. 5B, illustrates the output voltages (Vx₁₋₂) across the secondary DC-DC power converters. Furthermore, graph 508, in FIG. 5D, illustrates the high path (Ip) and low path (Ix) currents. By solving the above set of equations with the above values of power, the following equalities are derived
Iₚ=7.44 A
Iₓ=0.56 A
Vₓ₁=15 V
Vₓ₂=30.2 V
   In the equalities supra, “A” is the conventional symbol for ampere, the SI unit of electric current, and “V” is the conventional symbols for volt, the SI unit of electric potential difference. Moreover, the output voltages (Vx₁₋₂) across the secondary DC-DC power converters seen in graph 504 and the current values for Ip and Ix observed from graph 508, confirm these results.

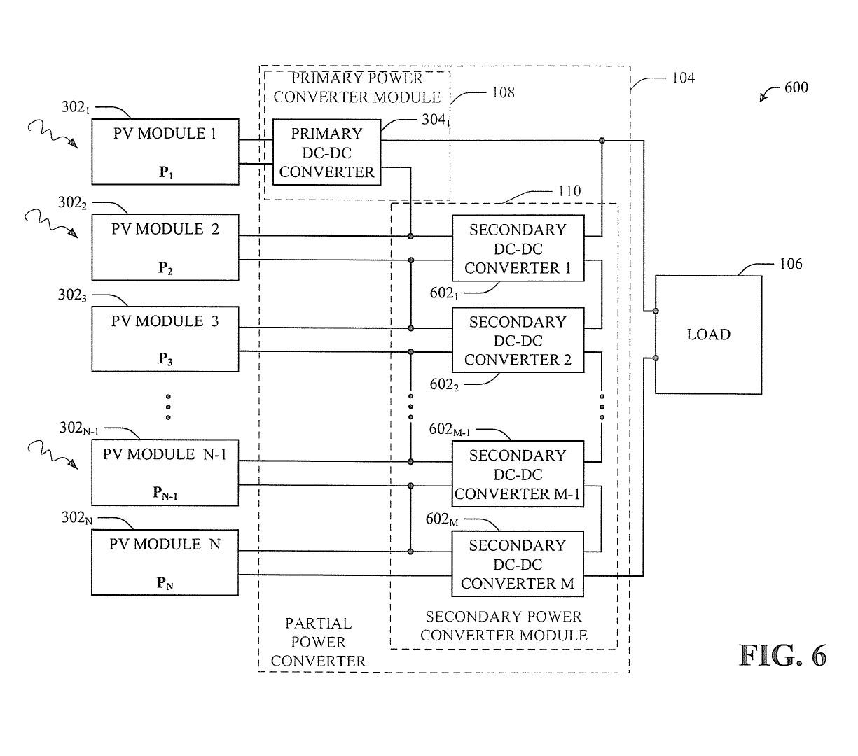

FIG. 6 illustrates a partial power controller architecture 600 utilized during power generation in accordance with an aspect of the specification. It can be appreciated that the partial power converter 104, the primary power converter module 108, load 106, PV modules 302_{1-N}, primary DC-DC converter 304₁, can include functionality, as more fully described herein, for example, with regard to systems 100 and 300. According to an aspect, the secondary power converter module 110 includes a set of secondary DC-DC converters 602_{1-M} (wherein M=N−1). Specifically, the secondary DC-DC converters 602_{1-M}, can include DC-DC power converters of most any rating or size (e.g., may or may not be DC-DC micro-converters).

In an embodiment, the size/rating of the secondary DC-DC converters 602_{1-M} can be varied based on various factors, such as, but not limited to, PV module rating, application, etc. For example, if the PV modules 302_{1-N} are setup in a location that receives a high amount of sunlight (e.g., a solar farm in a dessert), only a small amount of mismatch (e.g., due to manufacturing variations) or fluctuations are to be corrected and secondary DC-DC converters 602_{1-M} would need to supply relatively small amounts of power to compensate for the mismatch error (e.g., 1%). In this example scenario, micro-converters (e.g., 20-50 W) can be utilized as the secondary DC-DC converters 602_{1-M}. In another example, if the PV modules 302_{1-N} are installed in a shaded or partially shaded location, the secondary DC-DC converters 602_{1-M} would need to supply power to compensate for the shading (and mismatch, if any). Accordingly, the secondary DC-DC converters 602_{1-M} can include larger micro-converters, or even DC-DC power converters of the same (or substantially same) size and rating as the primary DC-DC converter 304. In this example scenario, the secondary DC-DC converters 602_{1-M} can boost all power, namely, Ix˜Ip, at the time output of a PV module goes below MPP (e.g., due to shading, damage, etc.)

In additional scenarios, the secondary DC-DC converters 602_{1-M} can be customized (in size and/or rating) based on expected operating conditions of the respective PV module 302_{1-N}. As an example, if it is determined that PV modules P₁, P₂, and P_{N-1}, receive sufficient amount of sunlight, while PV modules P₃ and P_{N} are usually shaded during certain period of operation, then corresponding smaller DC-DC micro-converters can be utilized for secondary DC-DC converters 602₁ and 602_{M-1} and relatively larger DC-DC micro-converters (or DC-DC power converters) can be utilized for secondary DC-DC converters 602₂ and 602_{M}. For example, in residential panels where some PV modules experience shading, secondary DC-DC converters corresponding to those PV modules can have 200 W DC-DC converters, while the remaining PV modules can exploit smaller 20-50 W DC-DC micro-converters. Moreover, the secondary DC-DC converters 602_{1-M} operate as needed, processing the energy that is not provided by the corresponding PV module 302_{1-N} or necessary to boost Ip. Accordingly, the secondary DC-DC converters 602_{1-M} provide a reliable system with an increased lifetime, by operating on an “as-needed” basis rather than in “always on” manner. In addition, the smaller DC-DC micro-converters, if utilized, provide various benefits, including, but not limited to reduced cost and size of the system, since smaller converters are cheaper and easier to install.

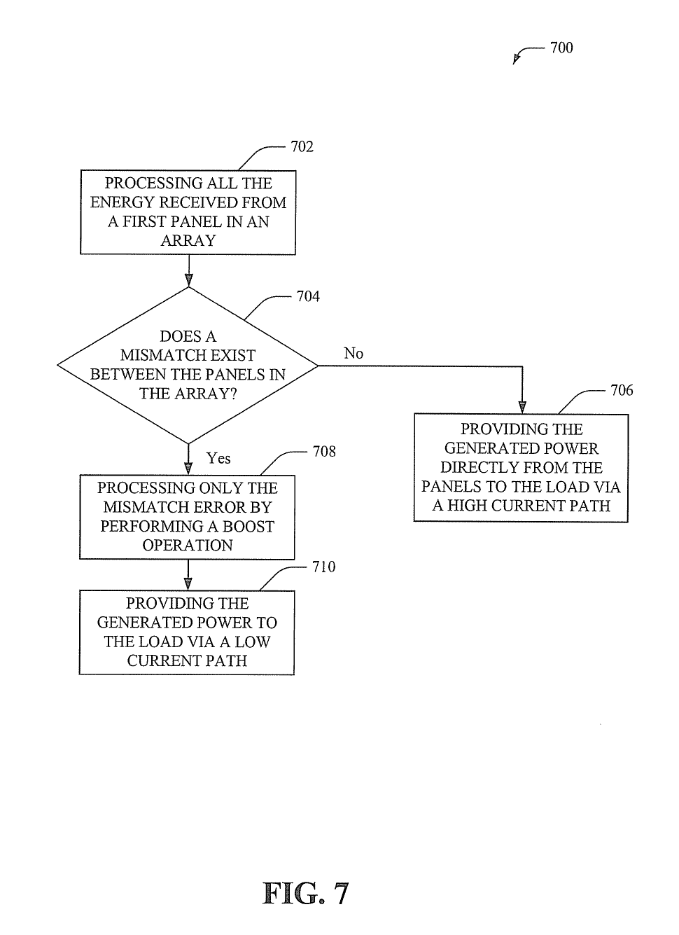

FIG. 7 illustrates a methodology 700 efficiently generating power by detecting and eliminating power mismatches between panels in an array of power sources, in accordance with the disclosed subject matter. For simplicity of explanation, the methodologies are depicted and described as a series of acts. It is to be understood and appreciated that the subject disclosure is not limited by the acts illustrated and/or by the order in which the acts are presented. For example acts can occur in various orders and/or concurrently, and with other acts not presented and described herein. Furthermore, not all illustrated acts may be required to implement the methodologies in accordance with the disclosed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device or computer-readable storage/communications media.

Typically, methodology 700 can be utilized in a power generation application, such as, but not limited to solar power generation. As an example, an array of power generation panels (e.g., PV panels) is employed to convert sunlight into electric power. Moreover, during operation the panels do not always operate at the MPP. In this scenario, the panel impedance is matched to the load impedance (e.g., by employing secondary power converters) to achieve MPP operation. At 702, all the power received from a first panel in the array is processed (e.g., by employing a primary power converter). At 704, it is determined whether an impedance mismatch exists between the panels in the array. In one aspect, if a mismatch does not exist, then at 706, the generated power is provided to the load directly from the panels via a high current path. Moreover, a boost operation is not performed for the remaining panels and the DC-DC converters utilized for the boost operation can be bypassed. Alternatively, if the mismatch exists, then at 708, the mismatch of the power panel is processed by performing a boost operation. As an example, one or more DC-DC micro-converters can be utilized to perform the boost operation. Further, at 710, the generated power is provided to the load via a low current path, for example, after performing the boost operation.

What has been described above includes examples of the subject disclosure. It is, of course, not possible to describe every conceivable combination of components or methodologies for purposes of describing the claimed subject matter, and many further combinations and permutations of the subject disclosure are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding figures, where applicable, it is to be understood that other similar embodiments can be used, or modifications and additions can be made to the described embodiments, for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

The aforementioned systems/circuits/modules have been described with respect to interaction between several components. It can be appreciated that such systems/circuits and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less that 10” can assume negative values, e.g. −1, −2, −3, −10, −20, −30, etc.

In addition, while a particular feature of the subject disclosure may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A power generation system, comprising:
an array of power sources that output electrical power; and
a partial power converter that connects the array to a load and regulates the electric power,
wherein the partial power converter includes a primary power converter module that processes the power generated by a first power source in the array, and a secondary power converter module that processes a power mismatch between the power sources in the array.

2. The power generation system of claim 1, wherein the primary power converter module includes at least one direct current (DC-DC) power converter coupled to the first power source.

3. The power generation system of claim 1, wherein the secondary power converter module includes one or more secondary power converters coupled to a remaining of the power sources in the array.

4. The power generation system of claim 3, wherein the one or more secondary power converters include at least a DC-DC power micro-converter.

5. The power generation system of claim 4, wherein the at least DC-DC power micro-converter has at least one of a rating or a size smaller than at least one of a rating or a size of the DC-DC power converter.

6. The power generation system of claim 1, further comprising: a high current path that provides the electric power to the load by bypassing the secondary power converter module, if the first power source is generating power above a predetermined level.

7. The power generation system of claim 1, further comprising: a low current path that provides power generated by the secondary power converter module to the load to provide power to the load above a predetermined level.

8. The power generation system of claim 1, wherein the power sources include photovoltaic (PV) modules.

9. The power generation system of claim 1, wherein the load is a DC-alternating current (AC) inverter.

10. A method for regulating power, comprising:
detecting power generated by a first power source and a second power source of an array of power sources;
using the power generated to determine a power mismatch between the first and the second power sources;
boosting the power generated by the first power source in response to detecting the mismatch; and
providing the boosted power to a load.

11. The method of claim 10, further comprising:
determining a power mismatch between a third power source and the second power source; and
boosting the power generated by the third power source in response to detecting the mismatch.

12. The method of claim 11, further comprising: detecting the power mismatch due to at least one of manufacturing variations, fluctuations, damage, temperature change, or shading.

13. The method of claim 11, further comprising: controlling an output of the first power source based on a maximum power point tracking for the first power source.

14. The method of claim 10, further comprising: providing power generated by the remaining of the power sources of the array directly to the load, in response to the power mismatch not being present between the second power source and the respective remaining power sources.

15. The method of claim 10, wherein determining the power mismatch includes processing the power generated by the power sources by employing a set of direct current (DC)-DC micro converters.

16. An integrated circuit, comprising:
a primary module that couples a first power generating panel, in an array of power generating panels, to a load through a primary power converter;
a secondary module that couples a remaining of the power generating panels in the array, to the load through a set of secondary power converters, and boosts power generated by at least one of the remaining of the power generating panels, in response to detection of a power mismatch in the array.

17. The integrated circuit of claim 16, further comprising: the primary power converter is configured to track a maximum power point (MPP) for the first power generating panel.

18. The integrated circuit of claim 16, wherein secondary module detects the power mismatch in the array.

19. The integrated circuit of claim 16, wherein the set of secondary power converters include at least one direct current (DC-DC) micro converter.

20. The integrated circuit of claim 16, wherein at least one of size or power rating of one of the set of secondary power converters is customized based on an expected operating condition of a respective power generating panel in the array.
